(19) United States
(12) Patent Application Publication
(10) Pub. No.: US 2022/0073058 A1
(43) Pub. Date: Mar. 10, 2022

(54) PARKING ASSISTANCE DEVICE

(71) Applicant: DENSO CORPORATION, Kariya-city (JP)

(72) Inventor: Koudai YAMAURA, Kariya-city (JP)

(21) Appl. No.: 17/531,190

(22) Filed: Nov. 19, 2021

Related U.S. Application Data
(63) Continuation of application No. PCT/JP2020/020125, filed on May 21, 2020.

(30) Foreign Application Priority Data
May 24, 2019 (JP) 2019-097816

(51) Int. Cl. B60W 30/06; G01C 21/00; G08G 1/14

(52) U.S. Cl. CPC B60W 30/06; G08G 1/148; G08G 1/142; G01C 21/3889

(57) ABSTRACT

A parking assistance device is configured to: control an automated guided vehicle that transports a first vehicle to a target position; provide parking assistance to a second vehicle having an automated valet parking function; determine whether or not a vehicle to be parked is the second vehicle; determine whether or not an ignition of the second vehicle is on when determining that the vehicle to be parked is the second vehicle; and transmit a command to turn on the ignition to the second vehicle when determining that the ignition of the second vehicle is off.

### CROSS REFERENCE TO RELATED APPLICATIONS

The present application is a continuation application of International Patent Application No. PCT/JP2020/020125 filed on May 21, 2020, which designated the U.S. and claims the benefit of priority from Japanese Patent Application No. 2019-097816 filed on May 24, 2019. The entire disclosures of all of the above applications are incorporated herein by reference.

### TECHNICAL FIELD

The present disclosure relates to a parking assistance device.

### BACKGROUND

There has been known a mixed parking facility. The mixed parking facility uses an automated guided vehicle to transport a vehicle without an automated valet parking function to a parking position.

The mixed parking facility transmits a signal indicating a parking position and a signal indicating a guidance route to the parking position to a vehicle having an automated valet parking function.

### SUMMARY

The present disclosure provides a parking assistance device configured to: control an automated guided vehicle that transports a first vehicle to a target position; provide parking assistance to a second vehicle having an automated valet parking function; determine whether or not a vehicle to be parked is the second vehicle; determine whether or not an ignition of the second vehicle is on when determining that the vehicle to be parked is the second vehicle; and transmit a command to turn on the ignition to the second vehicle when determining that the ignition of the second vehicle is off.

### BRIEF DESCRIPTION OF DRAWINGS

Objects, features and advantages of the present disclosure will become apparent from the following detailed description made with reference to the accompanying drawings. In the drawings:

FIG. 1 is an explanatory diagram showing a configuration of a parking lot system;

FIG. 2 is a block diagram showing configurations of a parking assistance device, an automated guided vehicle, and a vehicle having an automated valet parking function;

FIG. 3 is a block diagram showing a functional configuration of a controller included in the parking assistance device;

FIG. 4 is a flowchart showing a process executed by the parking assistance device;

FIG. 5 is a flowchart showing a transport control process executed by a transport control unit;

FIG. 6 is a flowchart showing a first assistance process executed by a parking assistance unit and a map information transmission unit;

FIG. 7 is a flowchart showing a second assistance process executed by the parking assistance unit;

FIG. 8 is a flowchart showing a transport process executed by the automated guided vehicle;

FIG. 9 is a flowchart showing a first automatic parking process executed by a vehicle having a first automated valet parking function;

FIG. 10 is an explanatory diagram showing an example of sequence executed by a user, a terminal, an infrastructure, the parking assistance device, the automated guided vehicle, and the vehicle;

FIG. 11 is an explanatory diagram showing another example of sequence executed by the user, the terminal, the infrastructure, the parking assistance device, the automated guided vehicle, and the vehicle; and

FIG. 12 is an explanatory diagram showing another example of sequence executed by the user, the terminal, the infrastructure, the parking assistance device, the automated guided vehicle, and the vehicle.

### DETAILED DESCRIPTION

Detailed studies by the inventor have found the following issues. An ignition of a vehicle transported by an automated guided vehicle may be on or off. However, if an ignition of a vehicle having an automated valet parking function is off, the vehicle cannot travel to a parking position.

A parking assistance device according to an aspect of the present disclosure includes a transport control unit, a parking assistance unit, a vehicle determination unit, an ignition determination unit, and a command transmission unit. The transport control unit is configured to control an automated guided vehicle that transports a first vehicle to a target position. The parking assistance unit is configured to provide parking assistance to a second vehicle having an automated valet parking function. The vehicle determination unit is configured to determine whether or not a vehicle to be parked is the second vehicle. The ignition determination unit is configured to determine whether or not an ignition of the second vehicle is on in response to the vehicle determination unit determining that the vehicle to be parked is the second vehicle. The command transmission unit is configured to transmit a command to turn on the ignition to the second vehicle in response to the ignition determination unit determining that the ignition of the second vehicle is off.

The parking assistance device having the above-described configuration can cause the second vehicle to travel to the target position even when the ignition of the second vehicle is initially off.

Hereinafter, embodiments of the present disclosure will be described with reference to the drawings.

### First Embodiment

1. Configuration of a Parking Lot System 1

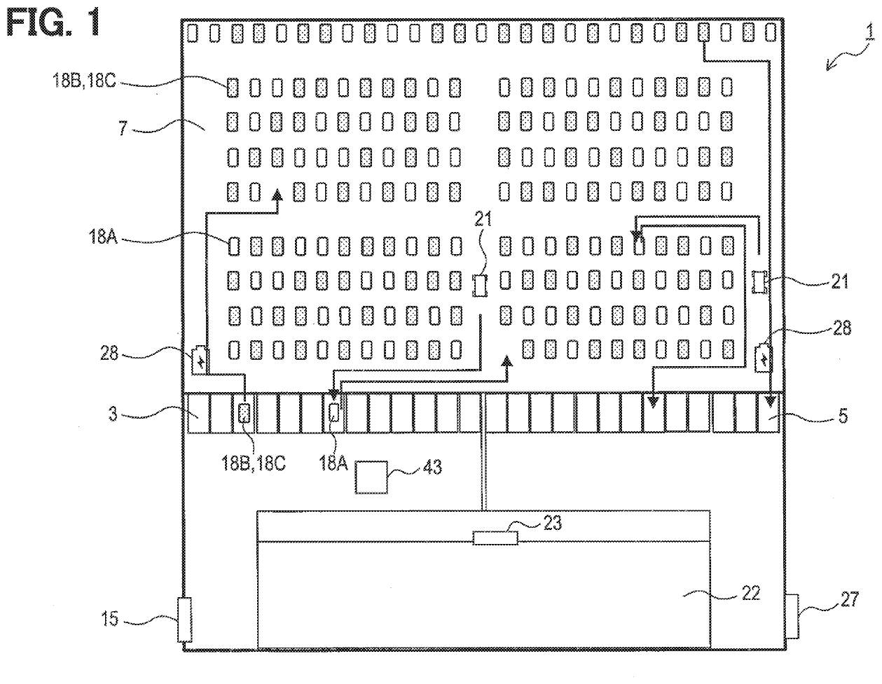

A configuration of a parking lot system 1 will be described with reference to FIGS. 1 to 3. As shown in FIG. 1, the parking lot system 1 includes an entering vehicle room 3, a leaving vehicle room 5, and a parking lot 7.

The entering vehicle room 3 is connected to the outside of the parking lot system 1 through an entrance 15. Vehicles 18 can enter the entering vehicle room 3 from the outside through the entrance 15. The vehicles 18 include a vehicle 18A without an automated valet parking function (AVP function), a vehicle 18B having a first automated valet parking function (first AVP function), and a vehicle 18C having a second automated valet parking function (second AVP function). The first automated valet parking function and the second automated valet parking function correspond to an automated valet parking function. The vehicle 18B and the vehicle 18C correspond to a second vehicle.

Both the first automated valet parking function and the second automated valet parking function have a function of traveling from the entering vehicle room 3 to the parking position in the parking lot 7 and parking by autonomous driving, and a function of traveling from the parking position in the parking lot 7 to the leaving vehicle room 5 by autonomous driving. The parking position corresponds to a target position.

The first automated valet parking function especially includes a function of repeatedly acquiring position information of the vehicle 18B and transmitting the position information to a parking assistance device (PAD) 39, and a function of determining a travel route of the vehicle 18B based on the position information of the vehicle 18B, a guidance route to the parking position, and map information. Each of the guidance route and the travel route is a route of the vehicle 18. The travel route is, for example, a route that is set in units of several centimeters and is more detailed than the guidance route.

The second automated valet parking function especially includes a function of receiving a travel route from the parking assistance device 39 described later, controlling the vehicle 18C according to the travel route, and traveling.

The second automated valet parking function does not include, for example, a function of acquiring position information of the vehicle 18C, and a function of determining the travel route of the vehicle 18C based on the position information of the vehicle 18C, a guidance route to the parking position, and the map information. The second automated valet parking function can be realized, for example, without the map information.

The parking lot system 1 includes multiple automated guided vehicles (AGV) 21. The configuration of the automated guided vehicles 21 will be described later. The entering vehicle room 3 and the leaving vehicle room 5 are adjacent to an entrance 23 of a facility 22 such as a store. An occupant of the vehicle 18 that has entered the entering vehicle room 3 can get off the vehicle 18 and proceed to the entrance 23 on foot.

The leaving vehicle room 5 is connected to the outside of the parking lot system 1 through an exit 27. The vehicle 18 can proceed from the leaving vehicle room 5 to the outside of the parking lot system 1 through the exit 27. The leaving vehicle room 5 is adjacent to the entrance 23. The occupant can walk to the leaving vehicle room 5 from the entrance 23.

The parking lot 7 is a place where multiple vehicles 18 can be parked. Multiple sections are provided inside the parking lot 7. Each section is an area where one vehicle 18 can be parked.

The vehicle 18 and the automated guided vehicle 21 can travel from the entering vehicle room 3 to the parking lot 7. The vehicle 18 and the automated guided vehicle 21 can travel from the parking lot 7 to the leaving vehicle room 5.

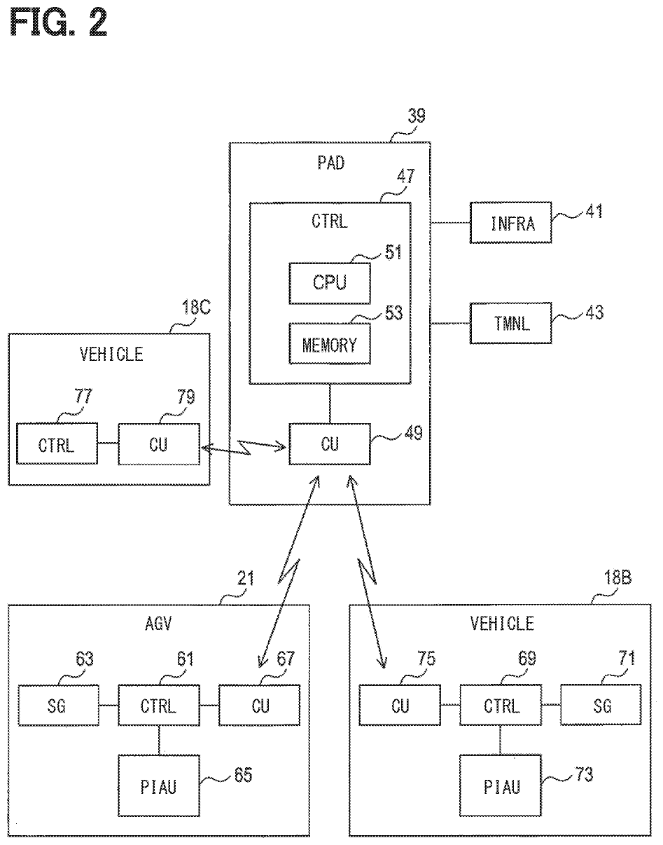

As shown in FIG. 2, the parking lot system 1 includes the parking assistance device 39, an infrastructure (INFRA) 41, and a terminal (TMNL) 43.

The parking assistance device 39 includes a controller (CTRL) 47 and a communication unit (CU) 49. The controller 47 includes a microcomputer having a CPU 51 and a semiconductor memory (hereinafter, a memory 53) such as a RAM or a ROM, for example.

Functions provided by the controller 47 are implemented by the CPU 51 executing a program stored in a non-transitory tangible storage medium. In this example, the memory 53 corresponds to the non-transitory tangible storage medium storing the program. When the program is executed, a method corresponding to the program is executed. The controller 47 may include one or more microcomputers.

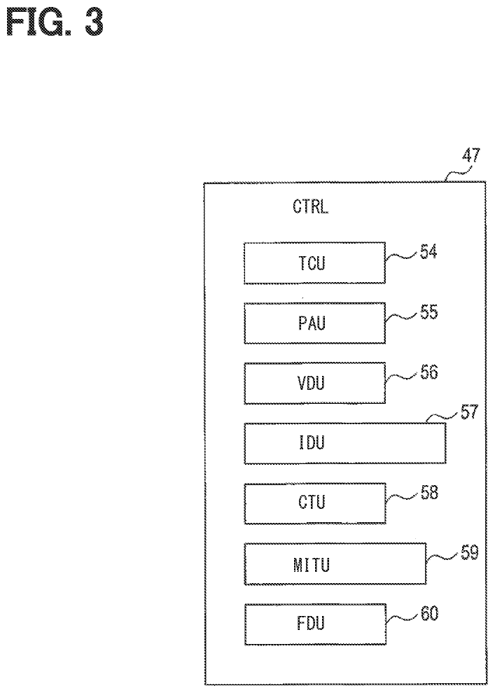

As shown in FIG. 3, the controller 47 includes a transport control unit (TCU) 54, a parking assistance unit (PAU) 55, a vehicle determination unit (VDU) 56, an ignition determination unit (IDU) 57, a command transmission unit (CTU) 58, a map information transmission unit (MITU) 59, and a function determination unit (FDU) 60.

The memory 53 stores the map information inside the parking lot system 1. In addition, the map information includes information indicating the state of the sections in the parking lot 7. The state of the sections includes a state where the section is vacant (hereinafter, referred to as a vacant state) and a state where the section is occupied by the vehicle 18 (hereinafter, referred to as an occupied state).

The communication unit 49 can communicate with the automated guided vehicle 21, the vehicle 18B, and the vehicle 18C. The communication interface between the communication unit 49 and the automated guided vehicle 21, the communication interface between the communication unit 49 and the vehicle 18B, and the communication interface between the communication unit 49 and the vehicle 18C may be the same or different.

The infrastructure 41 acquires information representing the state inside the parking lot system 1 (hereinafter referred to as parking lot information) and supplies the parking lot information to the parking assistance device 39. The infrastructure 41 includes a camera, a LiDAR, and the like that photograph the inside of the parking lot system 1.

Examples of the parking lot information include information indicating the position of an obstacle, information indicating the state of each section in the parking lot 7, and position information of the vehicles 18 present inside the parking lot system 1.

As shown in FIG. 1, the terminal 43 is installed in the vicinity of the entering vehicle room 3. The terminal 43 receives an input operation by an occupant. The terminal 43 outputs a signal corresponding to the input operation to the parking assistance device 39.

The terminal 43 outputs a parking request signal, for example, in response to the input operation. The parking request signal is a signal for requesting to transport the vehicle 18 in the entering vehicle room 3 to the parking lot 7 and park the vehicle 18. Further, the terminal 43 outputs identification information of the automated guided vehicle 21 or the vehicle 18 in response to the input operation, for example.

Further, the terminal 43 outputs, for example, a signal indicating a parking assistance method (hereinafter, referred to as an assistance method signal) in response to the input operation.

Examples of the parking assistance method include a method of transporting the vehicle 18 using the automated guided vehicle 21 and a method of assisting the vehicle 18 when the vehicle 18 travels to the parking lot 7 by using the automated valet parking function.

The terminal 43 outputs, for example, a leaving request signal or the like in response to the input operation. The leaving request signal is a signal requesting that the vehicle 18 parked in the parking lot 7 be transported to the leaving vehicle room 5. Further, the terminal 43 outputs identification information of the automated guided vehicle 21 or the vehicle 18 in response to the input operation, for example.

The automated guided vehicle 21 can, for example, travel in a state in which the vehicle 18 is mounted above the automated guided vehicle 21 (hereinafter, referred to as a mounting state). In addition, the automated guided vehicle 21 has a function of autonomously driving to the target position along the guidance route. The automated guided vehicle 21 can transport the vehicle 18 to the target position by autonomously driving to the target position along the guidance route in the mounted state. The vehicle 18 transported by the automated guided vehicle 21 corresponds to a first vehicle. The vehicle 18 transported by the automated guided vehicle 21 may be any of the vehicle 18A, the vehicle 18B, and the vehicle 18C.

As shown in FIG. 2, the automated guided vehicle 21 includes a controller (CTRL) 61, a sensor group (SG) 63, a positioning information acquisition unit (PIAU) 65, and a communication unit (CU) 67.

The controller 61 controls each unit of the automated guided vehicle 21. The function of the autonomous driving is realized by the control performed by the controller 61. The controller 61 holds map information inside the parking lot system 1. The automated guided vehicle 21 uses the map information, for example, when performing autonomous driving.

The sensor group 63 acquires peripheral information representing the situation around the automated guided vehicle 21. Examples of the contents of the peripheral information include a position of an obstacle present around the automated guided vehicle 21. The sensor group 63 includes a camera, a LiDAR, and the like. The automated guided vehicle 21 uses peripheral information when performing autonomous driving.

The position information acquisition unit 65 acquires position information of the automated guided vehicle 21. The position information acquisition unit 65 is a GPU system, for example. The automated guided vehicle 21 uses the position information when performing autonomous driving. The communication unit 67 can communicate with the parking assistance device 39.

The vehicle 18B has the first automated valet parking function as described above. As shown in FIG. 2, the vehicle 18B includes a controller (CTRL) 69, a sensor group (SG) 71, a position information acquisition unit (PIAU) 73, and a communication unit (CU) 75.

The controller 69 controls each unit of the vehicle 18B. The function of the autonomous driving is realized by the control performed by the controller 69. The vehicle 18B acquires the map information inside the parking lot system 1 from the parking assistance device 39. The vehicle 18B uses the map information acquired from the parking assistance device 39 when performing automatic driving.

The sensor group 71 acquires peripheral information representing the situation around the vehicle 18B. Examples of the contents of the peripheral information include a position of an obstacle present around the vehicle 18B. The sensor group 71 includes a camera, a LiDAR, and the like. The vehicle 18B uses peripheral information when performing autonomous driving.

The position information acquisition unit 73 acquires position information of the vehicle 18B. The position information acquisition unit 73 is, for example, a position estimation system using the LiDAR and a map. The vehicle 18B uses the position information when performing autonomous driving. The communication unit 75 can communicate with the parking assistance device 39.

The vehicle 18C has the second automated valet parking function as described above. As shown in FIG. 2, the vehicle 18C includes a controller (CTRL) 77 and a communication unit (CU) 79. The controller 77 controls each unit of the vehicle 18C. The function of the autonomous driving is realized by the control performed by the controller 77. The communication unit 79 can communicate with the parking assistance device 39.

2. Process Executed by the Parking Assistance Device 39

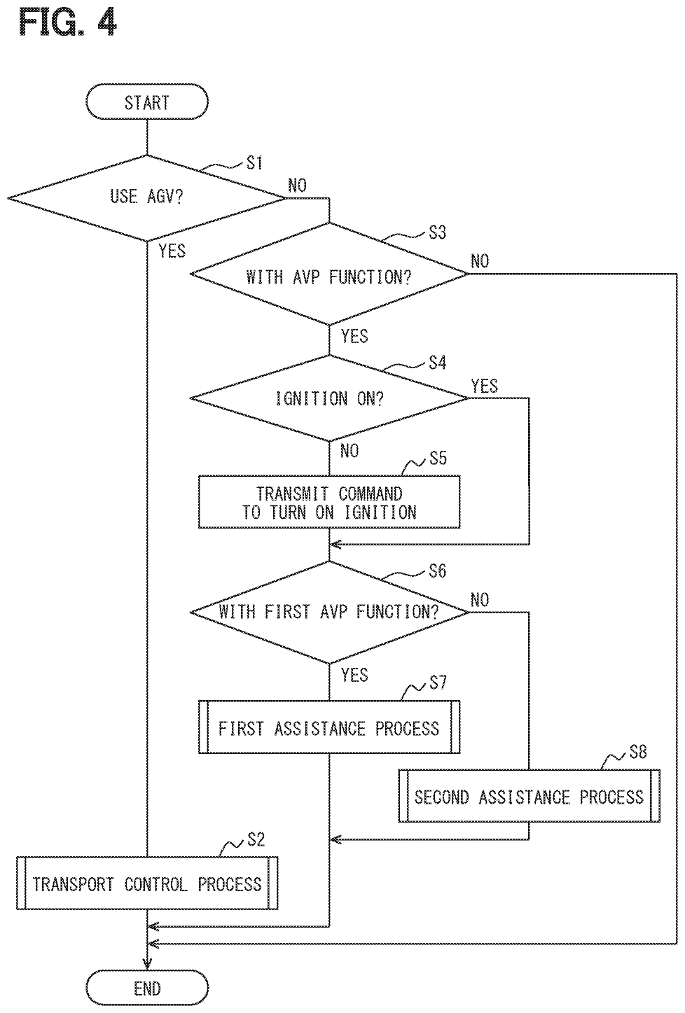

A process executed by the parking assistance device 39 when the terminal 43 outputs the parking request signal will be described with reference to FIGS. 4 to 7.

In S1 of FIG. 4, the transport control unit 54 determines whether or not the parking assistance method is the method of transporting the vehicle 18 using the automated guided vehicle 21. The transport control unit 54 determines the parking assistance method based on the assistance method signal output by the terminal 43. By operating the terminal 43, a user can select either the method of transporting the vehicle 18 using the automated guided vehicle 21 or the method of using the automated valet parking function of the vehicle 18. After selection, the user can leave the vehicle 18 and head for the destination.

When the parking assistance method is the method of transporting the vehicle 18 using the automated guided vehicle 21, the process proceeds to S2. When the parking assistance method is the method of assisting the vehicle 18 when the vehicle 18 travels to the parking lot 7 using the automated valet parking function, the process proceeds to S3.

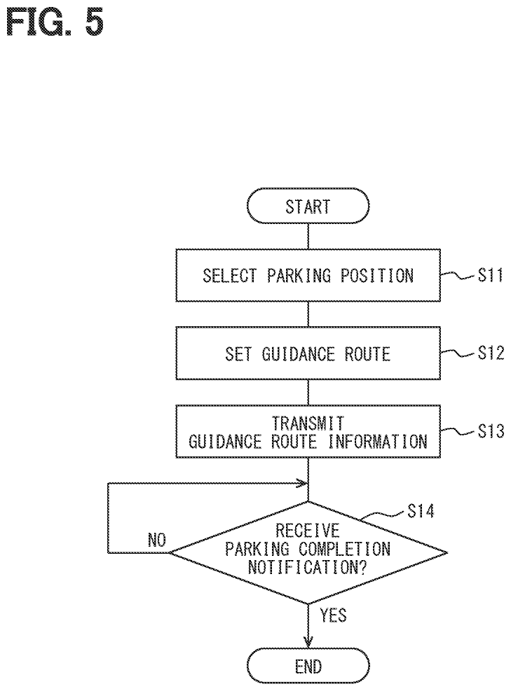

In S2, the transport control unit 54 executes a transport control process. The transport control process will be described with reference to FIG. 5.

In S11 of FIG. 5, the transport control unit 54 selects the parking position. The parking position is a section in the parking lot 7 that is in the vacant state. The transport control unit 54 determines the state of each section as follows, for example. When the vehicle 18 parks in a certain section, the vehicle 18 sends the identification information of the section and parking start information to the parking assistance device 39. Further, when the vehicle 18 leaves the previously parked section, the vehicle 18 sends the identification information of the section and parking end information to the parking assistance device 39.

The transport control unit 54 determines the state of each section based on the history of information sent from the vehicle 18. Further, the transport control unit 54 may determine the state of each section based on the information supplied by the infrastructure 41.

When there is only one vacant section, the transport control unit 54 sets that section as the parking position. When there are multiple vacant sections, the transport control unit 54 selects one section as the parking position from the multiple vacant sections based on a predetermined criteria. Examples of the criteria include selecting the section closest to the entering vehicle room 3, selecting the section closest to the leaving vehicle room 5, and selecting the section in an area where the vacant sections are gathered.

In S12, the transport control unit 54 sets the guidance route from the current position of the automated guided vehicle 21 to the parking position selected in S11 using the map information.

In S13, the transport control unit 54 transmits information representing the guidance route set in S12 (hereinafter referred to as guidance route information) using the communication unit 49. As will be described later, the automated guided vehicle 21 receives the guidance route information.

In S14, the transport control unit 54 determines whether or not the communication unit 49 has received parking completion notification. The parking completion notification is a notification transmitted by the automated guided vehicle 21 when the automated guided vehicle 21 is parked at the parking position. When the parking completion notification has been received, the process ends. When the parking completion notification has not been received, the process returns to a state before S14.

Returning to FIG. 4, in S3, the vehicle determination unit 56 inquires the vehicle 18 to be parked about the type of the vehicle 18 by using the communication unit 49. Types of vehicle 18 include the vehicle 18A, the vehicle 18B, and the vehicle 18C. The vehicle 18A is the vehicle 18 without an automated valet parking function. The vehicle 18B is the vehicle 18 having the first automated valet parking function. The vehicle 18C is the vehicle 18 having the second automated valet parking function.

The vehicle 18 transmits a response to the question. The vehicle determination unit 56 receives the response from the vehicle 18 using the communication unit 49. The vehicle determination unit 56 determines the type of vehicle 18 to be parked based on the received response. When the type of vehicle 18 to be parked is vehicle 18B or vehicle 18C, the process proceeds to S4. When the vehicle 18 to be parked is neither the vehicle 18B nor the vehicle 18C, the process ends.

In S4, the ignition determination unit 57 inquires of the vehicle 18 to be parked whether or not the ignition is on by using the communication unit 49. The vehicle 18 transmits a response to the question. The ignition determination unit 57 receives the response from the vehicle 18 using the communication unit 49. The ignition determination unit 57 determines whether or not the ignition of the vehicle 18 to be parked is on based on the received response. When the ignition of the vehicle 18 to be parked is on, the process proceeds to S6. When the ignition of the vehicle 18 to be parked is off, the process proceeds to S5.

In S5, the command transmission unit 58 transmits a command to turn on the ignition to the vehicle 18 by using the communication unit 49. The vehicle 18 turns on the ignition when receiving the command to turn on the ignition. The ignition on in S5 is an ignition on for operating the automated valet parking.

The ECU of the vehicle 18 is connected to a B power supply and can be activated constantly or intermittently to receive a command from the parking assistance device 39 even when the ignition is off. In response to a command from the parking assistance device 39, the vehicle 18 controls the ignition power to be turned on as the automated valet parking-only mode, and activates the ECU required for the automated valet parking.

In S6, the function determination unit 60 determines whether or not the vehicle 18 to be parked is the vehicle 18B based on the determination result in S3. The vehicle 18B is the vehicle 18 having the first automated valet parking function. When the vehicle 18 to be parked is the vehicle 18B, the process proceeds to S7. When the vehicle 18 to be parked is the vehicle 18C, the process proceeds to S8.

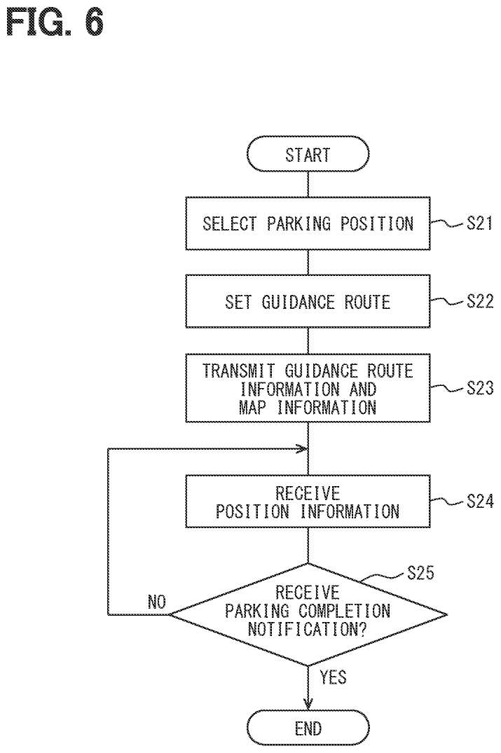

In S7, the parking assistance unit 55 and the map information transmission unit 59 execute the first assistance process. The first assistance process corresponds to a parking assistance. The parking assistance means performing at least a part of the processing required to realize the automated valet parking function. The first assistance process will be described with reference to FIG. 6.

In S21 of FIG. 6, the parking assistance unit 55 selects the parking position. The method of selecting the parking position is the same as in S11.

In S22, the parking assistance unit 55 sets the guidance route from the current position of the vehicle 18B to the parking position selected in S21 using the map information.

In S23, the parking assistance unit 55 transmits the guidance route information representing the guidance route set in S22 by using the communication unit 49. Further, the map information transmission unit 59 transmits the map information including the guidance route to the parking position by using the communication unit 49. As will be described later, the vehicle 18B receives the guidance route information and the map information.

In S24, the parking assistance unit 55 acquires the position information of the vehicle 18B. The vehicle 18B repeatedly transmits the position information.

In S25, the parking assistance unit 55 determines whether or not the communication unit 49 has received parking completion notification. The parking completion notification is a notification transmitted by the vehicle 18B when the vehicle 18B is parked at the parking position. When the parking completion notification has been received, the process ends. When the parking completion notification has not been received, the process returns to a state before S24.

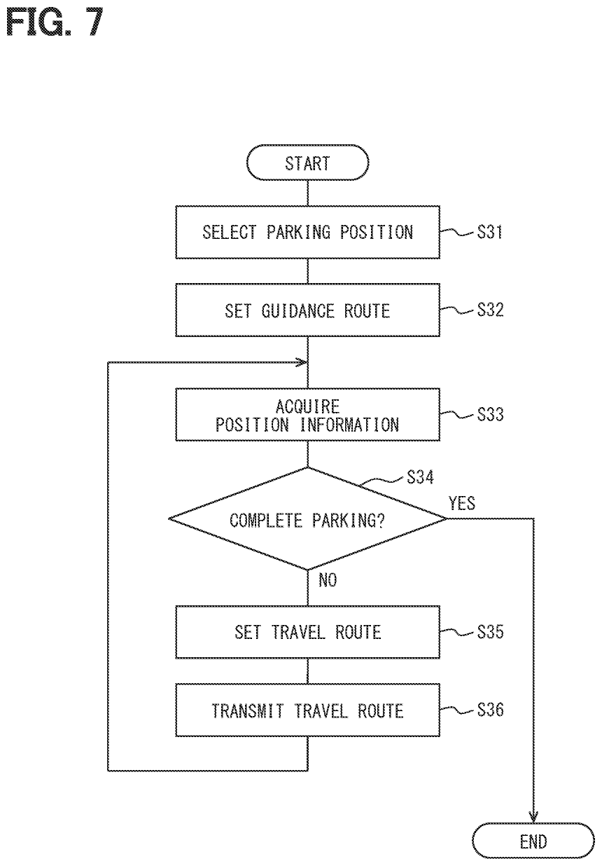

Returning to FIG. 4, in S8, the parking assistance unit 55 executes a second assistance process. The second assistance process corresponds to the parking assistance. The second assistance process will be described with reference to FIG. 7.

In S31 of FIG. 7, the parking assistance unit 55 selects the parking position. The method of selecting the parking position is the same as in S11. The parking position corresponds to the target position.

In S32, the parking assistance unit 55 sets the guidance route from the current position of the vehicle 18C to the parking position selected in S31 using the map information.

In S33, the parking assistance unit 55 acquires the position information of the vehicle 18C using the infrastructure 41.

In S34, the parking assistance unit 55 compares the parking position set in S31 with the position information acquired in S33. When the parking position and the position information match, the parking assistance unit 55 determines that the parking is completed and ends the process. When the parking position and the position information do not match, the parking assistance unit 55 determines that parking has not been completed, and the process proceeds to S35.

In S35, the parking assistance unit 55 sets the travel route of the vehicle 18C. The travel route is a detailed travel route set in units of several centimeters, which is necessary for the vehicle 18C to travel toward the parking position selected in the S31 along the guidance route set in the S32. The travel route is more detailed than the guidance route set in S32.

In S36, the parking assistance unit 55 transmits the travel route set in S35 to the vehicle 18C using the communication unit 49. The vehicle 18C receives the travel route. The vehicle 18C is controlled based on the received travel route. After S36, the process proceeds to S33.

3. Transport Process Executed by the Automated Guided Vehicle 21

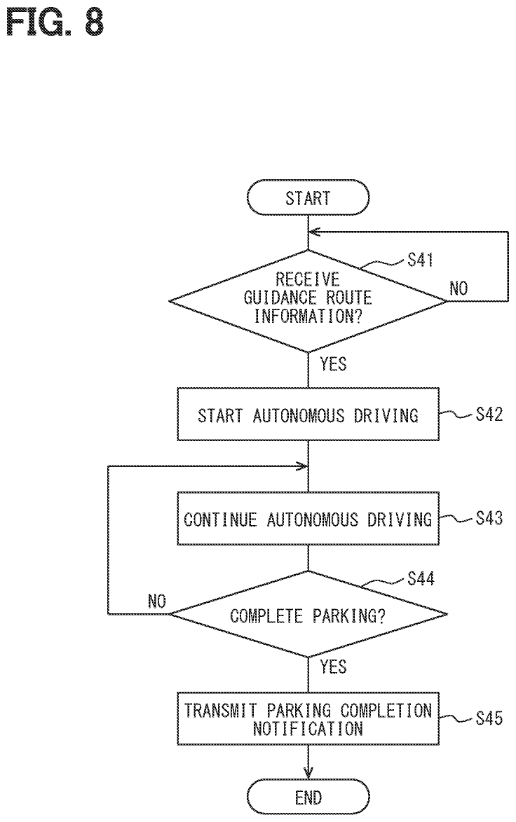

A transport process executed by the automated guided vehicle 21 will be described with reference to FIG. 8. The transport process is a process of transporting the vehicle 18 from the entering vehicle room 3 to the parking position according to the transport control process executed by the parking assistance device 39.

In S41, the controller 61 determines whether or not the communication unit 67 has been received the guidance route information. The guidance route information is transmitted by the parking assistance device 39 in S13. When the guidance route information has been received, the process proceeds to S42. When the guidance route information has not been received, the process returns to a state before S41.

In S42, the controller 61 starts autonomous driving. When performing autonomous driving, the controller 61 determines the travel route of the automated guided vehicle 21 based on the guidance route information, the map information held in advance, and the position information of the automated guided vehicle 21. The automated guided vehicle 21 travels by autonomous driving.

In S43, the controller 61 continues the autonomous driving. The controller 61 repeatedly transmits the position information of the automated guided vehicle 21 until it is determined that parking is completed in S45 described later. The transmitted position information is received by the parking assistance device 39.

In S44, the controller 61 determines whether or not parking is completed. Completion of parking means that the automated guided vehicle 21 and the vehicle 18 are parked at the parking position. When parking is completed, the process proceeds to S45. When parking is not completed, the process returns to a state before S43.

In S45, the controller 61 uses the communication unit 67 to transmit the parking completion notification. The parking assistance device 39 receives the transmitted parking completion notification. After parking is completed, the automated guided vehicle 21 is charged by a charging equipment 28 shown in FIG. 1, or the next transport is performed.

4. First Automatic Parking Process Executed by the Vehicle 18B

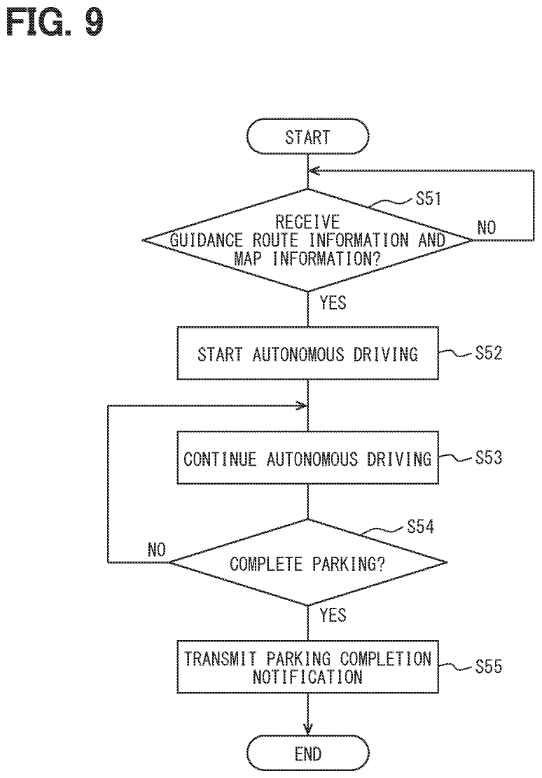

The first automatic parking process executed by the vehicle 18B will be described with reference to FIG. 9. The first automatic parking process is a process in which the vehicle 18B autonomously drives from the entering vehicle room 3 to the parking position in response to the first assistance process executed by the parking assistance device 39.

In S51, the controller 69 determines whether or not the communication unit 75 has received the guidance route information and the map information. The guidance route information is transmitted by the parking assistance device 39 in S23. When the guidance route information and the map information have been received, the process proceeds to S52. When the guidance route information and the map information have not been received, the process returns to a state before S51.

In S52, the controller 69 starts autonomous driving. When performing autonomous driving, the controller 69 determines the travel route of the vehicle 18B based on the guidance route information, the map information, and the position information of the vehicle 18B. The vehicle 18B travels by autonomous driving.

In S53, the controller 69 continues the autonomous driving. The controller 69 repeatedly transmits the position information of the vehicle 18B until it is determined that parking is completed in S53 described later. The transmitted position information is received by the parking assistance device 39.

In S54, the controller 69 determines whether or not parking is completed. Completion of parking means that the vehicle 18B parks at the parking position. When parking is completed, the process proceeds to S55. When parking is not complete, the process returns to S54.

In S55, the controller 69 uses the communication unit 75 to transmit the parking completion notification. The parking assistance device 39 receives the transmitted parking completion notification.

5. Second Automatic Parking Process Executed by the Vehicle 18C

A second automatic parking process executed by the vehicle 18C will be described. The second automatic parking process is a process in which the vehicle 18C autonomously drives from the entering vehicle room 3 to the parking position in response to the second assistance process executed by the parking assistance device 39. The controller 77 repeatedly receives the behavior of the vehicle using the communication unit 79. The behavior of the vehicle is transmitted by the parking assistance device 39 in S36. The controller 77 controls the vehicle 18C according to the received behavior of the vehicle.

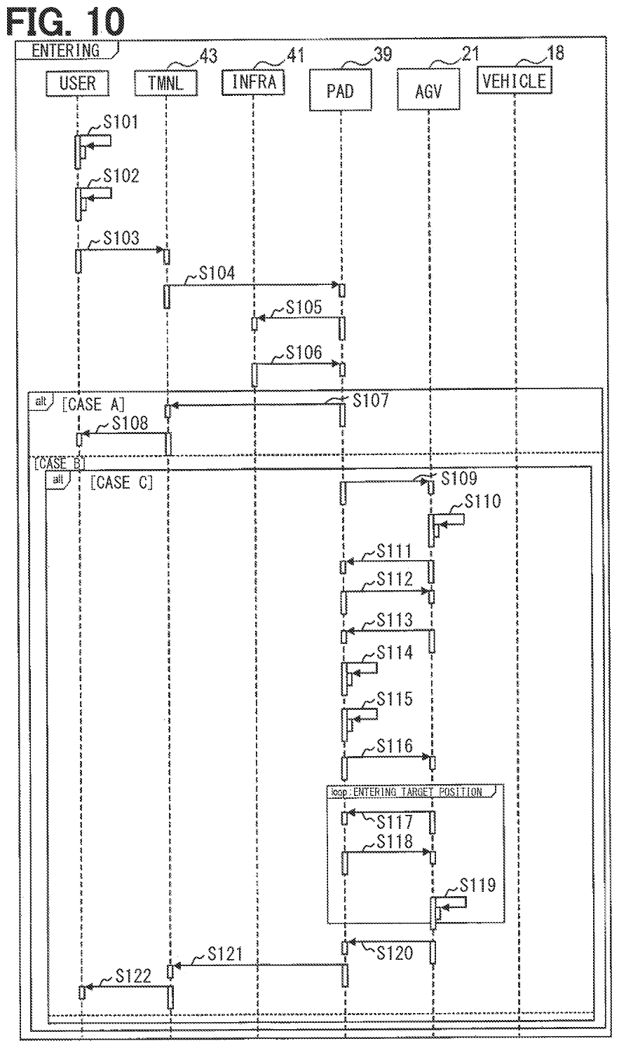

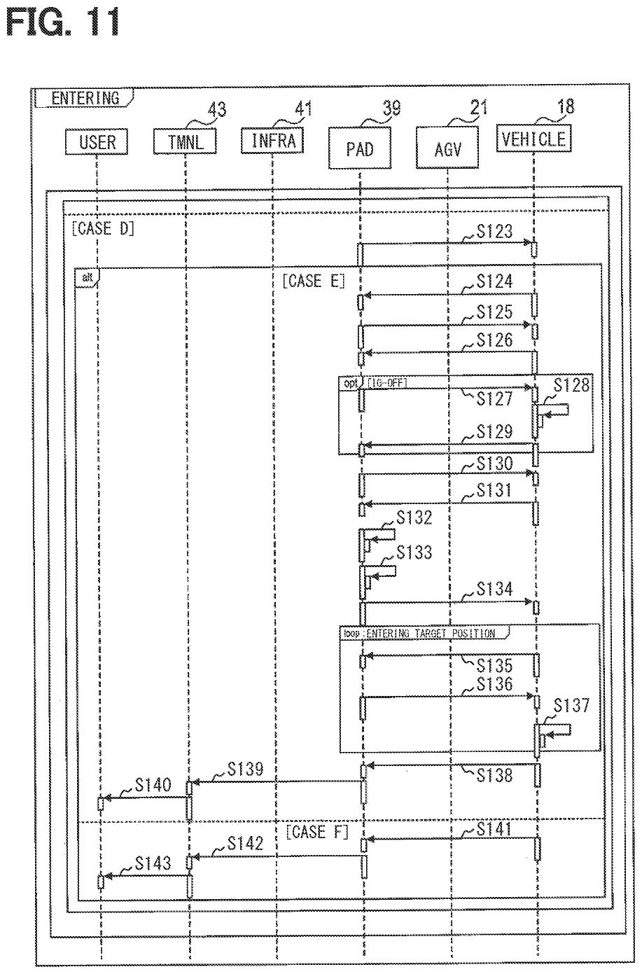

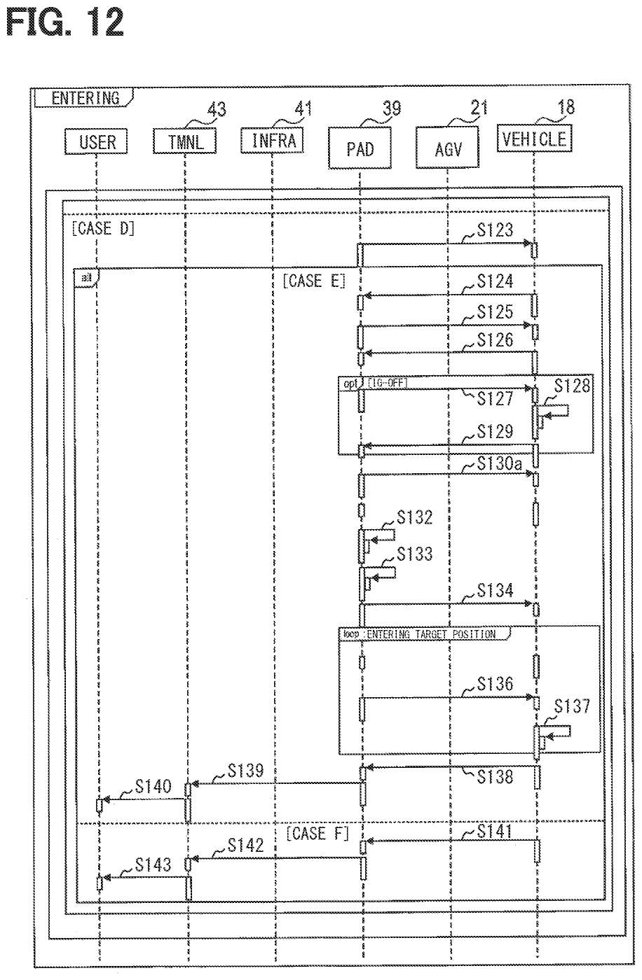

FIGS. 10 to 12 show examples of sequences executed by the user, the terminal 43, the infrastructure 41, the parking assistance device 39, the automated guided vehicle 21, and the vehicle 18. The sequence of FIG. 10 is a sequence when the transport control process of S2 is executed. The sequence of FIG. 11 is a sequence when the first assistance process of S7 is executed. The sequence of FIG. 12 is a sequence when the second assistance process of S8 is executed.

The sequence of FIGS. 10 to 12 will be described. In S100 in FIG. 10, the user parks the vehicle 18 at an entering start position.

In S102, the user gets off the vehicle 18.

In S103, the user inputs information to the terminal 43. The information includes whether or not the vehicle 18 is equipped with the automated valet function, an entering request, and the like.

In S104, the terminal 43 transmits the information input in S103 to the parking assistance device 39.

In S105, the parking assistance device 39 requests the infrastructure 41 to confirm whether or not the vehicle 18 is within the range where the automated valet parking is possible.

In S106, the infrastructure 41 notifies the parking assistance device 39 of the confirmation result of whether or not the vehicle 18 is within the range where the automated valet parking is possible.

When the vehicle 18 is not within the range where the automated valet parking is possible (hereinafter referred to as CASE A), the processes in S107 and S108 are performed. When the vehicle 18 is within the range where automated valet parking is possible (hereinafter referred to as CASE B), the processes in S107 and S108 are not performed.

In S107, the parking assistance device 39 notifies the terminal 43 that the vehicle 18 does not present in the range where the automated valet parking is possible.

In S108, the terminal 43 displays on the screen that the vehicle 18 is not present in the range where the automated valet parking is possible.

In S103, when the user inputs that the vehicle 18 is not equipped with the automated valet function (hereinafter referred to as CASE C), the processes in S109 to S122 are performed. In S103, when the user inputs that the vehicle 18 is equipped with the automated valet function (hereinafter referred to as CASE D), the processes in S109 to S122 are not performed.

In S109, the parking assistance device 39 instructs the automated guided vehicle 21 to lift up the vehicle 18.

In S110, the automated guided vehicle 21 determines whether or not the lift-up of the vehicle 18 is completed. When the lift-up is completed, the process proceeds to S111.

In S111, the automated guided vehicle 21 notifies the parking assistance device 39 of the completion of the lift-up.

In S112, the parking assistance device 39 transmits an entering start instruction to the automated guided vehicle 21.

In S113, the automated guided vehicle 21 notifies the parking assistance device 39 of the position of the automated guided vehicle 21 on the map.

In S114, the parking assistance device 39 sets a target entering position. The target entering position corresponds to the parking position.

In S115, the parking assistance device 39 creates a travel route from the current position of the automated guided vehicle 21 to the target entering position.

In S116, the parking assistance device 39 transmits the target entering position and the travel route to the automated guided vehicle 21.

In S117, the automated guided vehicle 21 travels toward the target entering position, and transmits the current position of the automated guided vehicle 21 to the parking assistance device 39.

In S118, the parking assistance device 39 performs a traffic management based on the position of the automated guided vehicle 21 received in S117. The parking assistance device 39 transmits instructions for stopping, starting, and rerouting to the automated guided vehicle 21 as necessary. The automated guided vehicle 21 stops, starts, and reroutes according to the instruction.

In S119, the automated guided vehicle 21 determines whether or not the automated guided vehicle 21 has arrived at the target entering position. When the automated guided vehicle 21 has not yet arrived at the target entering position, the process returns to S117. When the automated guided vehicle 21 has arrived at the target entering position, the processes in S117 to S119 are completed, and the process proceeds to S120.

In S120, the automated guided vehicle 21 notifies the parking assistance device 39 of the completion of entering.

In S121, the parking assistance device 39 notifies the terminal 43 of the completion of entering.

In S122, the terminal 43 notifies the user of the completion of entering.

In S103, when the user inputs that the vehicle 18 is equipped with the automated valet function (CASE D) and the vehicle 18 is the vehicle 18B, processes in S123 to S143 in FIG. 11 are performed. In S103, when the user inputs that the vehicle 18 is equipped with the automated valet function (CASE D) and the vehicle 18 is the vehicle 18C, processes in S123 to S143 in FIG. 12 are performed. In S103, when the user inputs that the vehicle 18 is not equipped with the automated valet function (CASE C), the processes S123 to S143 in FIGS. 11 and 12 are not performed.

The processes of S123 to S143 in FIG. 11 will be described. In S123, the parking assistance device 39 confirms whether or not the vehicle 18B is capable of performing the automated valet parking. When the vehicle 18B is capable of performing the automated valet parking (hereinafter referred to as CASE E), the processes in S124 to S140 are performed. When the vehicle 18B is not capable of performing the automated valet parking (hereinafter referred to as CASE F), the processes in S141 to S143 are performed.

In S124, the vehicle 18B notifies the parking assistance device 39 that the vehicle 18B will perform the automated valet parking.

In S125, the parking assistance device 39 inquires of the vehicle 18B whether or not the ignition of the vehicle 18B is on.

In S126, the vehicle 18B responses the parking assistance device 39 whether or not the ignition of the vehicle 18B is on. When content of the response is that the ignition of the vehicle 18B is off, the processes in S127 to S129 are performed. When the content of the response is that the ignition of the vehicle 18B is on, the processes in S127 to S129 are not performed.

In S127, the parking assistance device 39 instructs the vehicle 18B to turn on the ignition of the vehicle 18B.

In S128, vehicle 18B turns on the ignition.

In S129, the vehicle 18B notifies the parking assistance device 39 of that the ignition of the vehicle 18B has been turned on.

In S130, the parking assistance device 39 delivers the parking lot map to the vehicle 18B. Further, the parking assistance device 39 transmits the entering process start instruction to the vehicle 18B.

In S131, the vehicle 18B notifies the parking assistance device 39 of the position of the vehicle 18B on the map.

In S132, the parking assistance device 39 sets the target entering position. The target entering position corresponds to the parking position.

In S133, the parking assistance device 39 creates the travel route from the current position of the vehicle 18B to the target entering position.

In S134, the parking assistance device 39 transmits the target entering position and the travel route to the vehicle 18B.

In S135, the vehicle 18B travels toward the target entering position and transmits the current position of the vehicle 18B to the parking assistance device 39.

In S136, the parking assistance device 39 performs the traffic management based on the position of the vehicle 18B received in S135. The parking assistance device 39 transmits stop, start, and reroute instructions to the vehicle 18B as necessary. The vehicle 18B stops, starts, and reroutes according to the instructions.

In S137, the vehicle 18B determines whether or not the vehicle 18B has arrived at the target entering position. When vehicle 18B has not yet arrived at the target entering position, the process returns to S135. When the vehicle 18B has arrived at the target entering position, the processes of S135 to S137 are completed, and the process proceeds to S138.

In S138, the vehicle 18B notifies the parking assistance device 39 of the completion of entering.

In S139, the parking assistance device 39 notifies the terminal 43 of the completion of entering.

In S140, the terminal 43 notifies the user of the completion of entering.

In S141, the vehicle 18B notifies the parking assistance device 39 of an automated valet parking prohibition notification.

In S142, the parking assistance device 39 notifies the terminal 43 of the automated valet parking prohibition notification.

In S143, the terminal 43 notifies the user of the automated valet parking prohibition notification.

The processes of S123 to S143 in FIG. 12 are basically the same as the processes of S123 to S143 in FIG. 11. However, the process of S130a in FIG. 12 is different from the process of S130 in FIG. 11 in that the parking assistance device 39 does not deliver the parking lot map to the vehicle 18 and only transmits the entering process start instruction to the vehicle 18. Further, in the case of the process of FIG. 12, the vehicle 18 does not notify the parking assistance device 39 of the position of the vehicle 18 on the map. Further, in the case of the process of FIG. 12, the vehicle 18 is the vehicle 18C.

6. Effects of the Parking Assistance Device 39

(1A) The parking assistance device 39 can determine whether or not the vehicle 18 to be parked is one of the vehicle 18A, the vehicle 18B, or the vehicle 18C. When the vehicle 18 to be parked is the vehicle 18B or the vehicle 18C, the parking assistance device 39 can determine whether or not the ignition of the vehicle 18B or the vehicle 18C is on.

When the ignition of the vehicle 18B or the vehicle 18C is off, the parking assistance device 39 transmits the command to the vehicle 18B or the vehicle 18C to turn on the ignition. Therefore, even when the ignition of the vehicle 18B or the vehicle 18C is initially off, the parking assistance device 39 can provide parking assistance for the vehicle 18B or the vehicle 18C. The vehicle 18B and the vehicle 18C can be parked in the parking position by the automated valet parking function even when the ignition is initially off.

(1B) The parking assistance device 39 can the transmit map information to the vehicle 18B. the vehicle 18B can autonomously drive using the map information transmitted from the parking assistance device 39, for example, even if the vehicle 18B does not have the map information of the parking lot system 1 at the time of arriving at the entering vehicle room 3.

(1C) The parking assistance device 39 determines which of the vehicle 18B and the vehicle 18C is the vehicle 18 to be parked. The parking assistance device 39 transmits the map information to the vehicle 18B. The parking assistance device 39 does not transmit the map information to the vehicle 18C, for example. Therefore, the processing load of the parking assistance device 39 can be reduced. The vehicle 18C can realize the second automated valet parking function even if there is no map information.

(1D) The user who uses the mixed parking facility can carry out the entering procedure without minding whether the vehicle 18 has the automated valet parking function and whether the vehicle 18 has the automated valet parking function suitable for the parking lot system 1.

It is possible to park the vehicle 18 having the automated valet parking function and the ignition is off by using the automated guided vehicle 21. However, in that case, it takes time to wait for the automated guided vehicle 21, the rotation of the entering vehicles becomes poor, and the entering vehicle room becomes congested. According to the parking assistance device 39 of the present disclosure, the automated valet parking function of the vehicle 18 whose ignition is initially turned off can be exerted, and the above-described issues can be solved.

### Second Embodiment

1. Differences from the First Embodiment

Since the basic configuration of a second embodiment is similar to the first embodiment, differences will be described below. Note that the same reference numerals as those in the first embodiment indicate the same configuration, and refer to the preceding descriptions.

In the first embodiment described above, the parking assistance device 39 sets the target position of the guidance route to the final parking position. On the other hand, in the second embodiment, the target position of the guidance route is set to the vicinity of an initial parking position. When the vehicle 18B arrives in the vicinity of the initial parking position, the vehicle 18B recognizes the surrounding conditions, finally determines the parking position, and parks at the finally determined parking position. For example, when there are three vacant sections in the vicinity of the initial parking position, the vehicles 18B or 18C determine the final parking position from the three sections and park at the determined parking position.

2. Process Executed by the Parking Assistance Device 39

The parking assistance device 39 basically performs the process shown in FIG. 4. However, the parking assistance will be provided up to the vicinity of the initial parking position.

3. Effects of the Parking Assistance Device 39

According to the second embodiment described in detail above, the above-described effects (1A) and (1B) of the first embodiment are achieved.

### Other Embodiments

While the embodiments of the present disclosure has been described above, the present disclosure is not limited to the above embodiments and can be variously modified as exemplified below.

(1) The terminal 43 may be a terminal that can be carried by an occupant.

(2) In the first embodiment, the parking assistance device 39 may also transmit the map information to the vehicle 18C.

(3) The user can reserve the valet parking in advance with the parking assistance device 39 using a mobile terminal. At the time of reservation, the user can specify whether the vehicle 18 is the vehicle 18A, 18B, or 18C.

When the vehicle 18 arrives, the parking assistance device 39 determines whether the vehicle 18 is the vehicle 18A, 18B, or 18C based on the specification at the time of reservation. The parking assistance device 39 provides parking assistance according to the type of the vehicle 18.

Further, the vehicle determination unit 56 may determine whether or not the ignition of the vehicle 18 is on by using the infrastructure 41.

(4) The automated guided vehicle 21 does not have to use the map information. For example, a two-dimensional bar code is drawn on a floor of the parking lot system 1 at predetermined intervals. The automated guided vehicle 21 is provided with a camera on a lower surface thereof. The automated guided vehicle 21 recognizes the position of the automated guided vehicle 21 while reading the two-dimensional bar code using the camera, and receives a route instruction from the parking assistance device 39. Examples of the two-dimensional bar code include a QR code (registered trademark) and the like.

(5) The vehicle 18B may perform a process of setting a guidance route to the parking position. The process of setting the guidance route to the parking position is, for example, the same process as in S22.

(6) The parking assistance device 39 can determine, for example, whether or not the vehicles 18B and 18C conforms to the parking assistance device 39. One example of cases that does not conform to the parking assistance device 39 is a case where the vehicle 18 is the vehicle 18B when the parking assistance device 39 cannot perform the first assistance process. Another example of cases that does not conform to the parking assistance device 39 is a case where the vehicle 18 is the vehicle 18C when the parking assistance device 39 cannot perform the second assistance process. For example, when the parking assistance device 39 determines that the vehicle 18B or 18C does not conform to the parking assistance device 39, the parking assistance device 39 does not send the command to turn on the ignition to the vehicle 18B or 18C.

The controller 47 and method described in the present disclosure may be implemented by a dedicated computer which is configured with a memory and a processor programmed to execute one or more particular functions embodied in computer programs of the memory. Alternatively, the controller 47 and the method according to the present disclosure may be achieved by a dedicated computer which is configured with a processor with one or more dedicated hardware logic circuits. Alternatively, the controller 47 and the method according to the present disclosure may be achieved using one or more dedicated computers which is configured by a combination of a processor and a memory programmed to execute one or more functions and a processor with one or more hardware logic circuits. Further, the computer program may be stored in a computer-readable non-transitory tangible storage medium as instructions to be executed by a computer. The technique for realizing the functions of each unit included in the controller 47 does not necessarily need to include software, and all the functions may be realized using one or a plurality of hardware circuits.

(8) A plurality of functions of one constituent element in the above embodiment may be realized by a plurality of constituent elements, or a single function of one constituent element may be realized by a plurality of constituent elements. Further, multiple functions of multiple elements may be implemented by one element, or one function implemented by multiple elements may be implemented by one element. A part of the configuration of the above embodiments may be omitted. At least a part of the configuration of the above embodiments may be added to or replaced with the configuration of another one of the above embodiments.

(9) In addition to the above-described parking assistance device, the present disclosure may be realized by various features such as a system including the parking assistance device as a component, a program for functioning the computer as the controller in the parking assistance device, a non-transitory tangible storage medium such as a semiconductor memory storing the program, a parking assistance method or the like.

What is claimed is:

1. A parking assistance device comprising:
a transport control unit configured to control an automated guided vehicle that transports a first vehicle to a target position;
a parking assistance unit configured to provide parking assistance to a second vehicle having an automated valet parking function;
a vehicle determination unit configured to determine whether or not a vehicle to be parked is the second vehicle;
an ignition determination unit configured to determine whether or not an ignition of the second vehicle is on in response to the vehicle determination unit determining that the vehicle to be parked is the second vehicle;
a command transmission unit configured to transmit a command to turn on the ignition to the second vehicle in response to the ignition determination unit determining that the ignition of the second vehicle is off; and
a conformity determination unit configured to determine whether or not the automated valet parking function of the second vehicle conforms to the parking assistance device, wherein
the command transmission unit is further configured not to transmit the command to turn on the ignition in response to the conformity determination unit determining that the automated valet parking function of the second vehicle does not conform to the parking assistance device.

2. The parking assistance device according to claim 1, further comprising
a map information transmission unit configured to transmit map information including a route to the target position to the second vehicle in response to the vehicle determination unit determining that the vehicle to be parked is the second vehicle.

3. The parking assistance device according to claim 1, further comprising:
a function determination unit configured to determine whether or not the second vehicle has a function of determining a travel route in response to the vehicle determination unit determining that the vehicle to be parked is the second vehicle; and
a map information transmission unit configured to transmit map information including a route to the target position to the second vehicle in response to the function determination unit determining that the second vehicle has the function of determining the travel route.

4. The parking assistance device according to claim 1, wherein
the command transmission unit is further configured not to transmit the command to turn on the ignition to the second vehicle in a case where the second vehicle is transported by the automated guided vehicle.

5. A parking assistance device comprising a processor and a memory, the memory storing instructions configured to, when executed by the processor, cause the processor to:
control an automated guided vehicle that transports a first vehicle to a target position;
provide parking assistance to a second vehicle having an automated valet parking function;
determine whether or not a vehicle to be parked is the second vehicle;
determine whether or not an ignition of the second vehicle is on when determining that the vehicle to be parked is the second vehicle;
transmit a command to turn on the ignition to the second vehicle when determining that the ignition of the second vehicle is off;
determine whether or not the automated valet parking function of the second vehicle conforms to the parking assistance device; and
prohibit transmission of the command to turn on the ignition when determining that the automated valet parking function of the second vehicle does not conform to the parking assistance device.

6. The parking assistance device according to claim 5, wherein
the instructions are further configured to, when executed by the processor, cause the processor to transmit map information including a route to the target position to the second vehicle when determining that the vehicle to be parked is the second vehicle.

7. The parking assistance device according to claim 5, wherein
the instructions are further configured to, when executed by the processor, cause the processor to:
determine whether or not the second vehicle has a function of determining a travel route when determining that the vehicle to be parked is the second vehicle; and
transmit map information including a route to the target position to the second vehicle when determining that the second vehicle has the function of determining the travel route.

8. The parking assistance device according to claim 5, wherein
the instructions are further configured to, when executed by the processor, cause the processor not to transmit the command to turn on the ignition to the second vehicle in a case where the second vehicle is transported by the automated guided vehicle.
